(19) United States
(12) Patent Application Publication
(10) Pub. No.: US 2015/0076752 A1
(43) Pub. Date: Mar. 19, 2015

(54) PNEUMATIC SPRING SHOCK ABSORBER APPARATUS FOR A MOTOR VEHICLE

(71) Applicant: Dr. Ing. h.c. F. Porsche Aktiengesellschaft, Stuttgart (DE)

(72) Inventor: Rainer Hennemann, Friolzheim (DE)

(21) Appl. No.: 14/478,379

(22) Filed: Sep. 5, 2014

(30) Foreign Application Priority Data
Sep. 16, 2013 (DE) 102013110148.8

(51) Int. Cl. B60G 15/12

(52) U.S. Cl. CPC B60G 15/12; B60G 2202/32; B60G 2206/82
USPC 267/64.24

(57) ABSTRACT

For the mounting of an abutment cap on a shock absorber tube, use is made of the pneumatic spring in which the abutment cap is held. During the joining process of the pneumatic spring onto the shock absorber, the abutment cap is pushed onto the shock absorber and, in a further process, is pressed on, wherein here, the clamp of the abutment cap or the holding webs of the abutment cap slips or break, respectively, and the pneumatic spring can assume a final position in the apparatus.

### CROSS-REFERENCE TO RELATED APPLICATIONS

This application claims priority to German Patent Application No. DE 10 2013 110 148.8, filed Sep. 16, 2013, which is incorporated by reference herein it its entirety.

### FIELD OF THE INVENTION

The invention relates to a pneumatic spring shock absorber apparatus for a motor vehicle.

### BACKGROUND OF THE INVENTION

DE 44 15 045 C1, which is incorporated by reference herein, discloses a pneumatic spring shock absorber apparatus in which the pneumatic spring is supported on a shock absorber tube via a rolling tube which is supported on a piston rod. Above the shock absorber tube there is held an abutment cap which is situated opposite an auxiliary spring. To be mounted, the abutment cap is inserted into the rolling tube and connected thereto. These are then assembled with the pneumatic spring, which is pushed over the abutment cap.

### SUMMARY OF THE INVENTION

Described herein is a pneumatic spring shock absorber apparatus for a motor vehicle, in which an abutment cap, which is arranged within a pneumatic spring, for a shock absorber tube can be connected to the shock absorber tube in a simple mounting process.

An advantage obtained by the invention consist in that, by means of a joining process of a pneumatic spring onto a shock absorber tube of a pneumatic spring shock absorber apparatus, an abutment cap for an auxiliary spring can simultaneously be placed above the shock absorber tube. In order to be mounted on the shock absorber tube the abutment cap is connected to the inside of the pneumatic spring such that, during a joining process of the pneumatic spring to the shock absorber tube, the abutment cap is pushed on in a pre-mounting position, and in a final mounted position, said abutment cap is pressed onto the end side of the shock absorber tube and the pneumatic spring is situated in a final position on the apparatus. The abutment cap is fastened to the pneumatic spring by clamping means or by means of radially projecting holding webs on the abutment cap. Such mounting of the abutment cap with the pneumatic spring is required because the abutment cap has a relatively large external diameter and the pneumatic spring has a relatively small internal diameter, and thus subsequent mounting of the pneumatic spring on the shock absorber tube is no longer possible.

In the pre-mounting position, the abutment cap which is held in the pneumatic spring can be located above and on the end side of the shock absorber tube by way of the pneumatic spring which, during a joining process, is placed onto the shock absorber tube, wherein the abutment cap in the pneumatic spring is in a sunken, recessed position.

In said position, the abutment cap is placed on above the shock absorber tube and the pneumatic spring is arranged such that its lower end is still spaced apart from the lower end of the shock absorber tube. In said pre-mounting position, the force of the clamping means of the abutment cap or the breaking force of the holding webs of the abutment cap is greater than the force with which the abutment cap is pressed onto the shock absorber tube. By means of these force conditions, the abutment cap is connected fixedly to the pneumatic spring, wherein the latter is arranged so as to be pushed onto the shock absorber tube.

In the final mounted position, the abutment cap which is held in the pneumatic spring is arranged, during the joining process, so as to be pressed onto the shock absorber tube, and the holding webs of the abutment cap slip or break when the pneumatic spring assumes a compressed final position on the shock absorber tube, and the abutment cap in the pneumatic spring is situated in the pneumatic spring in an elevated final position. A compression of the pneumatic spring causes the abutment cap to be pressed, as it were, onto the free end of the shock absorber tube. The abutment cap is guided initially by means of the clamping action or by means of the holding webs.

In the final mounted position, the abutment cap which is held in the pneumatic spring is pressed on with a force greater than the clamping forces of the abutment cap or the breaking force of the holding webs on the abutment cap.

### BRIEF DESCRIPTION OF THE DRAWINGS

An exemplary embodiment of the invention is illustrated in the drawings and will be described in more detail below.

In the drawings:

FIG. 1 is a schematic illustration of a spring shock absorber apparatus in a pre-mounting position with an abutment cap which is held in a pneumatic spring and which has been pushed onto the shock absorber tube, and

FIG. 2 is a schematic illustration of the spring shock absorber apparatus in a final mounted position of the pressed-on abutment cap on the shock absorber tube, with the pneumatic spring released from the abutment cap in a final position.

### DETAILED DESCRIPTION OF THE INVENTION

A pneumatic spring shock absorber apparatus for a motor vehicle has a pneumatic spring 3 pushed onto a shock absorber tube 2, in which shock absorber tube there is held an abutment cap 4, which is arranged on the end side of the shock absorber tube 2, for an auxiliary spring.

To be mounted on the shock absorber tube 2, the abutment cap 4 is connected to the inside of the pneumatic spring 3. During a joining process of the pneumatic spring 3 to the shock absorber tube 2, the abutment cap 4 is, in one position, placed onto the end side of the shock absorber tube 2, and the pneumatic spring 3 assumes a final position on the apparatus 1.

For the mounting process, the abutment cap 4 is fastened in the pneumatic spring 3 by clamping means or by means of radially projecting holding webs 5 of the abutment cap 4, which clamping means or holding webs slips or break, respectively, under the action of a certain load.

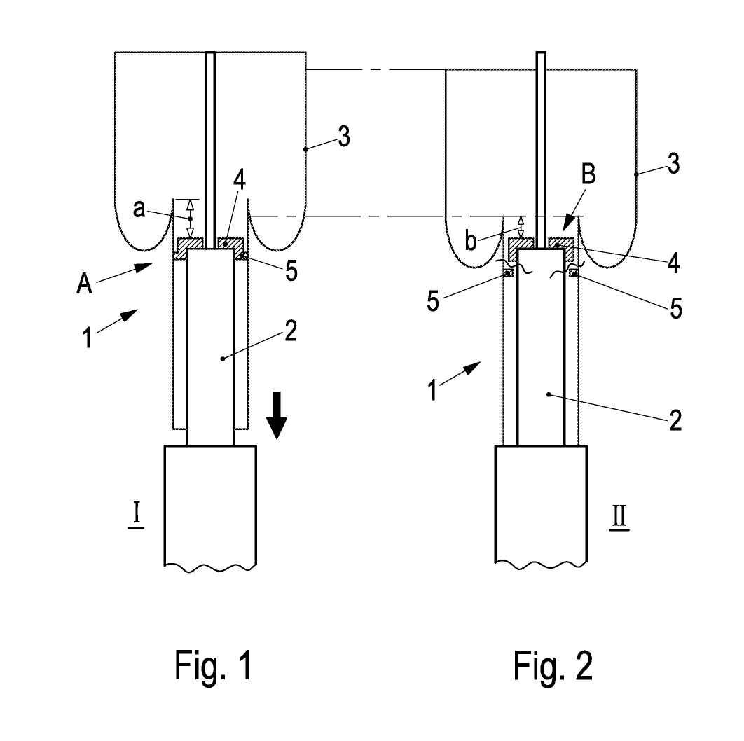

In a pre-mounting position I as per FIG. 1, the abutment cap 4 held or fastened in the pneumatic spring 3 is located above and on the end side of the shock absorber tube 2 by way of the pneumatic spring 3 which, during a joining process, is placed onto the shock absorber tube 2 in the direction of the arrow (FIG. 1). In said pre-mounting position I, the cap 4 is held in a recessed position A, sunken into the pneumatic spring 3, with the dimension a. In said position I, the force of the clamping means of the abutment cap 4 or the breaking force of the holding webs 5 of the abutment cap 4 is greater than the force with which the abutment cap 4 is pressed onto the shock absorber tube 2, such that the abutment cap 4 continues to be held securely and fixedly in the pneumatic spring 3.

In a subsequent final mounted position II (FIG. 2), the abutment cap 4 which is held in the spring 3 is, during the joining process, pressed onto the shock absorber tube 2 and the holding webs 5 of the abutment cap 5 can slip or break when the pneumatic spring 3 assumes a compressed final position on the apparatus 1. The abutment cap 4 then assumes, in the pneumatic spring 3, an elevated position B with the dimension b (FIG. 2), by contrast to the recessed position A, with the relatively large dimension a (FIG. 1), in the pneumatic spring 3.

In said final mounted position II, the abutment cap 4 held in the pneumatic spring 3 is pressed onto the shock absorber tube 2 with a force greater than the clamping force of the abutment cap 4 or the breaking force of the holding webs 5 in the abutment cap 4, such the abutment cap 4 can slip or the holding webs 5 can break.

What is claimed is:

1. A pneumatic spring shock absorber apparatus for a motor vehicle, having a pneumatic spring which is arranged on a shock absorber tube and on which there is arranged an abutment cap which is held on the shock absorber tube,
wherein the abutment cap is, in order to be mounted on the shock absorber tube, connected to an inside of the pneumatic spring such that, during a joining process of the pneumatic spring to a shock absorber tube, the abutment cap is placed in a pre-mounting position, and
wherein in a final mounted position, said abutment cap is pressed onto an end side of the shock absorber tube and the pneumatic spring is situated in a final position on the apparatus.

2. The apparatus as claimed in claim 1, wherein the abutment cap is fastened to the pneumatic spring by clamping means or by means of radially projecting holding webs of the abutment cap.

3. The apparatus as claimed in claim 2, wherein, in the pre-mounting position, a force of the clamping means of the abutment cap or a breaking force of the holding webs of the abutment cap is greater than a force with which the abutment cap is pressed onto the shock absorber tube.

4. The apparatus as claimed in claim 3, wherein, in the final mounted position, a force with which the abutment cap is pressed onto the shock absorber tube is greater than the clamping forces of the abutment cap or the breaking force of the holding webs on the abutment cap.

5. The apparatus as claimed in claim 2, wherein, in the pre-mounting position, the abutment cap which is held in the pneumatic spring is located above and on the end side of the shock absorber tube by way of the pneumatic spring which, during a joining process, is arranged so as to be placed onto the shock absorber tube, wherein the abutment cap in the pneumatic spring is in a sunken, recessed intermediate position (A) having a first depth (a).

6. The apparatus as claimed in claim 5, wherein, in the final mounted position, the abutment cap which is held in the pneumatic spring is arranged, during the joining process, so as to be pressed onto the shock absorber tube, and the clamping means or the holding webs of the abutment cap slips or break, respectively, when the pneumatic spring assumes a compressed final position on the shock absorber tube, and the abutment cap is situated in the pneumatic spring in an elevated final position (B) having a second depth that is different than the first depth (b).
